(19) United States
(12) Patent Application Publication
(10) Pub. No.: US 2007/0140496 A1
(43) Pub. Date: Jun. 21, 2007

(54) Escrow compatible key generation

(75) Inventor: Thomas L. Phinney, Glendale, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/303,045

(22) Filed: Dec. 15, 2005

(51) Int. Cl. H04L 9/28; H04K 1/06; H04L 9/00; H04K 1/04

(52) U.S. Cl. 380/286; 380/44; 380/28; 380/37

(57) ABSTRACT

A method of managing encryption keys creates a new encryption key as a predictable and retrospectively repeatable function of a current encryption key. Information is then encrypted or authenticated using the new encryption key. In one embodiment, the generation of a new encryption key is triggered as a function of the amount of information encrypted or authenticated using the current encryption key. In a further embodiment, the new encryption key is created by using the current encryption key to encrypt a pre-agreed block of information, which may be an appropriate-length representation of the current encryption key. In a further embodiment, the current encryption key and a time-independent method of creating a new encryption key is escrowed.

### BACKGROUND

Encryption or authentication of messages and other data has become a standard practice of businesses and individuals to safeguard the information when transmitted over a public network, such as the Internet, or via wireless communication mechanisms. Many different encryption or authentication methods involve algorithms that encrypt information as a function of a key, such as a 128 bit string. Usually, the longer the key, the more difficult it is to decrypt the information, or to undetectably modify or forge the information, without knowledge of the key.

When keys are used for too long a time, a significant amount of information becomes encrypted or authenticated under the same key. A larger amount of encrypted or authenticated information under the same key makes it easier to determine how to decrypt the information, or forge undetectably modified or replaced information, without knowing the key, especially if that encrypted or authenticated information contains predictable or repetitive information.

When two strings that are to be encrypted or authenticated have an identical initial portion, and the encryption algorithm when encrypting or authenticating, respectively, each string has the same initial encryption state information and uses the same key, then it is possible to determine, at least partially, how to decrypt both messages, or to undetectably modify either message or forge a third related message, respectively. For this reason it is normal practice to ensure that either some portion of that initial encryption state, or some of that initial portion of the string to be encrypted or authenticated, respectively, or both, differs between each two instances of encryption or authentication, respectively, under the same key. Whether part of the string itself, or separate initial state, this portion that differs with each instance of encryption or authentication, respectively, is known commonly as an “initialization vector”.

Escrow of keys is done to allow select investigative organizations to obtain keys to monitor information being transmitted. Often this monitoring is retrospective, analyzing information that was transmitted and recorded at an earlier time. Changing keys often to reduce the volume of encrypted or authenticated information under one key makes it difficult to manage an escrow of the keys. There may be communication breakdowns or other events which make communication of new keys to all concerned systems difficult. There is a need for a better way to manage escrow of keys while controlling the amount of information encrypted or authenticated under any one key.

### SUMMARY

A method of managing encryption keys creates a new encryption key as a predictable and retrospectively repeatable function of a current encryption key. Information is then encrypted or authenticated using the new encryption key. In one embodiment, the transition to the use of a new encryption key is a function of the amount of information encrypted or authenticated using the current encryption key. In a further embodiment, the new encryption key is used after a predetermined number of times of use of the current encryption key.

In yet a further embodiment, the new encryption key is created by using the current encryption key to encrypt a pre-agreed block of information, which may be an appropriate-length representation of the current encryption key. In a further embodiment, the current encryption key and a time-independent, or only coarsely time-dependent, method of creating a new encryption key is escrowed.

### BRIEF DESCRIPTION OF THE DRAWINGS

FIG. 1 is a block diagram of a system utilizing an encryption key escrow policy and mechanism according to an example embodiment.

FIG. 2 is a block diagram of a typical computer system for implementing aspects of various example embodiments.

FIG. 3 is a flow chart illustrating new key generation according to an example embodiment.

FIG. 4 is a flow chart illustrating new key generation and escrowing of the key according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or, in one embodiment, in a combination of software and human implemented procedures. The software comprises computer executable instructions stored on computer readable media such as memory or other type of storage devices. The term “computer readable media” is also used to represent any means by which the computer readable instructions may be received by the computer, such as by different forms of wireless transmissions. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating as a computer system, such as a personal computer, server, digital instrument or other computer system.

A block diagram of a system implementing encryption key escrow and devices communicating using encryption keys is first described, along with a block diagram of a typical computer system capable of using the encryption key and changing keys in a manner that is predictable and retrospectively repeatable by an escrow agent. In one embodiment, the change is effected in a known time-independent manner. The term “time-independent” is meant to include changing keys in a coarsely time-dependent manner. This is followed by description of algorithms for using current encryption keys and generating the new keys. The term “encryption key” is meant to encompass the use of the key for authentication and for decryption.

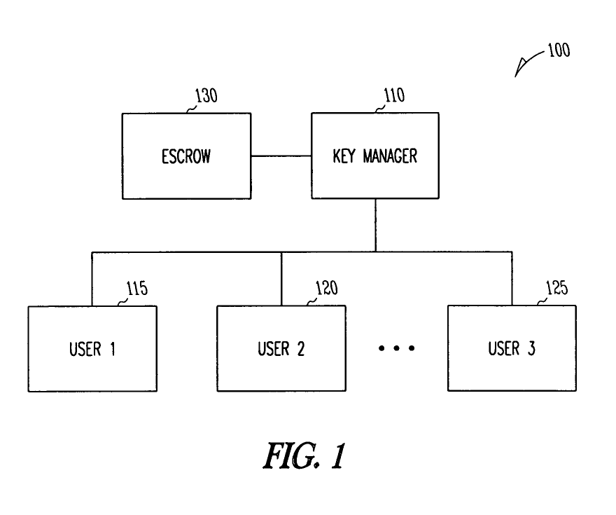

FIG. 1 is a block diagram of a system 100 utilizing encryption key escrow according to an example embodiment. An encryption key manager 110, which is sometimes called a key distribution center, is coupled to multiple users 115, 120 and 125, and provides an encryption key for use by such users. In one embodiment, secret-key symmetric encryption is used. Further embodiments may use different key encryption algorithms, including public/private-key asymmetric encryption. The encryption key is also provided to an escrow system 130 via the encryption key manager 110. In addition to the key, a method of changing the key in a predictable and retrospectively repeatable manner, such as a time-independent manner is also provided to the users, the encryption key manager and the escrow system. In one embodiment, the method comprises simply encrypting a current key to generate a new key, using the current key both as the encryption key and, in an appropriate-length representation, as the string to be encrypted. Any user can generate the new key when appropriate.

The new key generation may be triggered by a passage of a predetermined amount of time, the encryption of a predetermined amount of information, or after a predetermined number of uses of the current encryption key. This may be done to prevent a large amount of information from being encrypted or authenticated by the same key, or to prevent duplication under the same key of the information being used as an “initialization vector”. The encryption or authentication of too much information using the same key renders it easier to decrypt the encrypted information, or to modify or forge messages undetectably, respectively, without having the key. The encryption of two strings using the same “initialization vector” may make it possible to decrypt at least part of both strings and to determine at least partial content relationships between the remaining portions of the two strings. The authentication of two strings using the same “initialization vector” may make it possible to modify undetectably either string, or to forge undetectably a related string.

In one embodiment, the new key is generated by simply encrypting the current key using the current key both as the encryption key and, in an appropriate-length representation, as the string to be encrypted. Successive new keys may be generated in the same manner. Any other type of method that is predictable and retrospectively repeatable may be used. In one embodiment, a method that is not time-dependent, or that is only coarsely time-dependent, may also be used, such as encrypting strings predictable to the escrow system and other intended users of the key, for example, encrypting successive integers represented as strings. The use of a time-dependent method, where the precise time of next-key generation affects the resulting new key, can make any later determination of the generated key by the escrow system extremely difficult. Use of a method that includes the coarse time of key use, such as the expected first hour or first day of key use, causes only minor difficulty in such a later determination. It is predictable and retrospectively repeatable in that an escrow agent may repeat the generation of the new key within a limited number of tries using a coarse time.

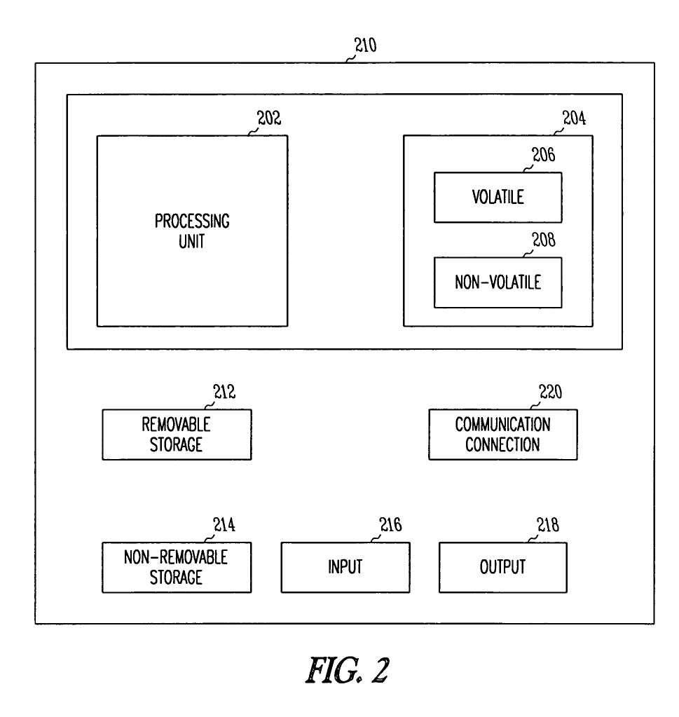

FIG. 2 is a block diagram of a typical computer system for implementing aspects of various example embodiments. As used with this invention, a general computing device in the form of a computer 210, may include a processing unit 202, memory 204, and a communication connection 220. Memory 204 may include volatile memory 206 and non-volatile memory 208, such as may be used for storage of at least one master encryption key. Computer 210 may include—or have access to a computing environment that includes—a variety of computer-readable media, such as volatile memory 206 and non-volatile memory 208, removable storage 212 and non-removable storage 214. Memory and computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 210 may include or have access to a computing environment that includes input 216 and output 218. With regard to the purposes of this description, elements 212, 214, 216 and 218 are optional. As used with this invention, each computer may operate in a networked environment using a communication connection to connect to one or more remote computers. The remote computer may include a digital instrument, a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 202 of the computer 210. A hard drive, RAM and non-volatile memory are some examples of articles including a computer-readable medium.

FIG. 3 is a flowchart illustrating new key generation according to an example embodiment. At 310, a current encryption key is used to encrypt information. It should be noted that, in various embodiments, the key may also be used to authenticate information, or both encrypt and authenticate information. FIG. 3 thus refers to encrypting or authenticating to represent these various embodiments. At 320, a new encryption key is created as a predictable and retrospectively repeatable function of the current encryption key. In one embodiment, the new key is simply the result of encrypting the current key using the current key both as the encryption key and, in an appropriate-length representation, as the string to be encrypted. In further embodiments, the new key may be generated based on a number predictable to the escrow system and other intended users of the key, expressed as a string of the same length as that required for the encryption algorithm. At 330, information is now encrypted or authenticated using the new key. The fact that a new key is being used may be communicated explicitly to other devices, or they may infer its use on receipt of a message encrypted or authenticated, respectively, under the new key.

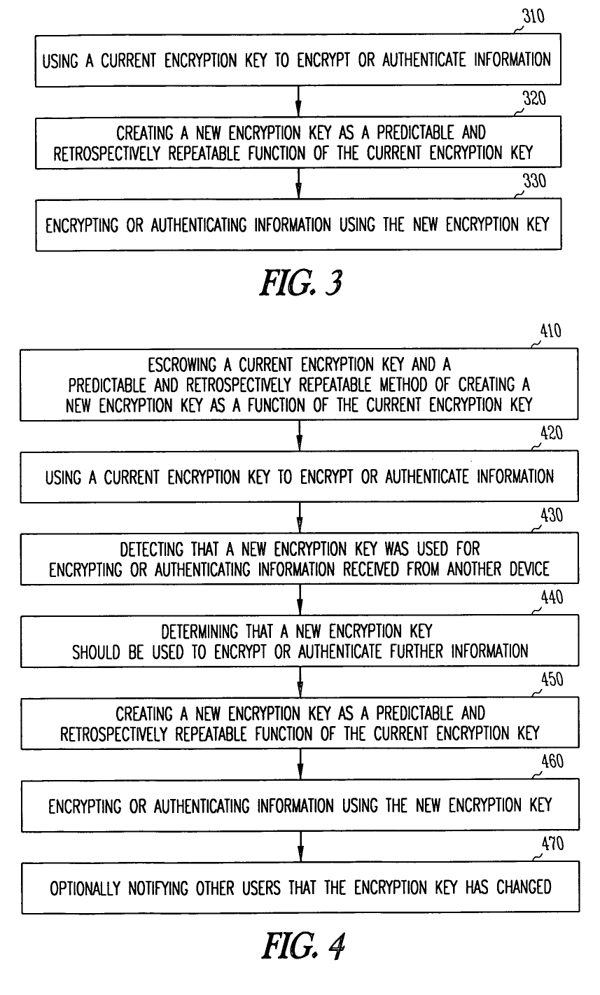

FIG. 4 is a flowchart illustrating new key generation and escrowing of the key according to an example embodiment. At 410, a current encryption key and a predictable and retrospectively repeatable method of creating a new encryption key is escrowed. It should be noted that, in various embodiments, the key may also be used to authenticate information, or both encrypt and authenticate. FIG. 4 thus refers to encrypting or authenticating to represent these various embodiments. The current encryption key is then used by one or more devices or systems to encrypt or authenticate information at 420.

In one embodiment, information received from another device may be encrypted or authenticated using a new key. Since the information so encrypted or authenticated, respectively, cannot be decrypted or authenticated, respectively, using the current key, it may be assumed that a new key was generated, and the device may then determine that it needs to generate a corresponding new key in order to decrypt or authenticate, respectively, such information at 440.

In one embodiment, the new encryption key is created as a predictable and retrospectively repeatable function at 450. The key may also be created as a function of the current encryption key. In further embodiments, it may be created based on a string of bits predictable to the escrow system and other intended users of the key. Other methods of creating a new key that can be reliably and safely reconstructed at an arbitrary later time by an investigative organization, based solely on escrowed information, the approximate time at which the key was used, or both, also may be used. Information may then be encrypted or authenticated using the new key at 460. Other users may optionally be notified that the key has been changed at 470, or may detect that a new key is being used by being unable to decrypt or authenticate, respectively, received information using a current key, generating a new key, trying to decrypt or authenticate, respectively, the received information using the new key, and succeeding at that decryption or authentication, respectively.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A method comprising:
using a current encryption key to encrypt or authenticate information;
creating a new encryption key as a predictable and retrospectively repeatable function of the current encryption key; and
encrypting or authenticating information using the new encryption key.

2. The method of claim 1 wherein transition to use of the new encryption key occurs as a function of the amount of information encrypted or authenticated, or both, using the current encryption key.

3. The method of claim 1 wherein the new encryption key is used after a predetermined amount of time of using the current encryption key.

4. The method of claim 1 wherein the new encryption key is used after a predetermined number of times of use of the current encryption key.

5. The method of claim 1 wherein the new encryption key is created by using the current encryption key to encrypt a block of information predictable to the escrow system and other intended users of the key.

6. The method of claim 5 wherein the block of information that is predictable to the escrow system and other intended users of the key is an appropriate-length representation of the current encryption key.

7. The method of claim 1 and further comprising successively changing keys in a time-independent manner to create and use a succession of new encryption keys, with the new key becoming the current key.

8. The method of claim 1 wherein the transition to use of a new encryption key is triggered as a function of the amount of information encrypted or authenticated, or both, using the current encryption key if no new key has been received from an escrowing key generator within an expected time.

9. The method of claim 1 wherein the transition to use of a new encryption key is triggered as a function of the number of instances of encryption or authentication, or both, using the current encryption key if no new key has been received from an escrowing key generator within an expected time.

10. A system comprising:
means for encrypting or authenticating information using a current encryption key;
means for creating a new encryption key as a predictable and retrospectively repeatable function of the current encryption key; and
means for transitioning from use of the current encryption key to use of the new encryption key as a function of the amount of information encrypted or authenticated using the current encryption key.

11. The system of claim 10 wherein the transition from use of the current encryption key to use of the new encryption key occurs after a predetermined amount of time.

12. The system of claim 10 wherein the transition from use of the current encryption key to use of the new encryption key occurs after a predetermined number of times of use of the current encryption key.

13. The system of claim 10 wherein the new encryption key is created by using the current encryption key to encrypt a pre-agreed block of information.

14. The system of claim 13 wherein the pre-agreed block of information is an appropriate-length representation of the current encryption key.

15. The system of claim 10 and further comprising means for notifying users of the change of encryption key.

16. A method comprising:
escrowing a current encryption key and a predictable and retrospectively repeatable method of creating a new encryption key as a function of the current encryption key;
using a current encryption key to encrypt or authenticate information;
creating a new encryption key using the time-independent, or only coarsely time-dependent, method; and
encrypting or authenticating information using the new encryption key.

17. The method of claim 16 and further comprising detecting that an encryption key has been changed.

18. The method of claim 17 wherein detecting that an encryption key has been changed comprises unsuccessfully using a current encryption key to decrypt received information.

19. The method of claim 16 and further comprising notifying other users of the current encryption key that the current encryption key has been changed.

20. The method of claim 16 and further comprising providing the current encryption key and time-independent method of creating a new encryption key to multiple users.
